(19) United States
(12) Patent Application Publication
(10) Pub. No.: US 2015/0066922 A1
(43) Pub. Date: Mar. 5, 2015

(54) SYSTEM AND METHOD FOR RECOMMENDING MULTIMEDIA CONTENT

(71) Applicants: SONY NETWORK ENTERTAINMENT INTERNATIONAL LLC, Los Angeles, CA (US); SONY CORPORATION, Tokyo (JP)

(72) Inventors: True Xiong, San Diego, CA (US); Charles McCoy, Coronado, CA (US); Leo Pedlow, Ramona, CA (US)

(73) Assignees: SONY NETWORK ENTERTAINMENT INTERNATIONAL LLC, Los Angeles, CA (US); SONY CORPORATION, Tokyo (JP)

(21) Appl. No.: 14/014,684

(22) Filed: Aug. 30, 2013

(51) Int. Cl. G06F 17/30

(52) U.S. Cl. CPC G06F 17/30017
USPC 707/736

(57) ABSTRACT

Various aspects of a system and a method for recommending multimedia content are disclosed herein. The method is included in a server communicatively coupled to a first electronic device operable to execute a first application and a second application. The method receives a first plurality of user preferences. The received first plurality of user preferences comprises a set of metadata corresponding to a first multimedia content rendered during the execution of the first application at the first electronic device. The method recommends second multimedia content to a user through a multimedia distribution channel during execution of the second application based on the received first plurality of user preferences.

### FIELD

Various embodiments of the disclosure relate to recommending multimedia content. More specifically, the disclosure relates to recommending multimedia content to a user based on user preferences.

### BACKGROUND

Recent advancements in the Internet technology have made it possible for multimedia content to be made available online by a multimedia server to one or more electronic devices.

Currently, multimedia servers may be configured to recommend multimedia content to a user associated with an electronic device during an execution of an application, for example, Windows Media Player®. Such a recommendation may be based on pre-specified user preferences. For example, the user may subscribe to a particular genre of online multimedia content outside of the application and may set preferences for receiving multimedia content during execution of the application.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method are provided for recommending multimedia content substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a network environment for recommending multimedia content, in accordance with an embodiment of the disclosure.

FIG. 2 is a block diagram illustrating an electronic device, in accordance with an embodiment of the disclosure.

FIG. 3 is a block diagram illustrating a multimedia server, in accordance with an embodiment of the disclosure.

FIG. 4 illustrates an exemplary interface of an exemplary electronic device, in accordance with an embodiment of the disclosure.

FIG. 5 is a flow chart illustrating a method for recommending multimedia content, in accordance with an embodiment of the disclosure.

### DETAILED DESCRIPTION

The following described implementations may be found in a system and/or a method for recommending multimedia content. Exemplary aspects of the disclosure may comprise a method for recommending multimedia content. The method may be included in a server communicatively coupled to a first electronic device. The first electronic device may be operable to execute a first application and a second application. The method may include receiving a first plurality of user preferences. The first plurality of user preferences may include a set of metadata corresponding to a first multimedia content rendered during execution of the first application at the first electronic device. The method may also include recommending second multimedia content to a user through a multimedia distribution channel during execution of the second application based on the received plurality of user preferences.

In an embodiment, the first application and the second application may be one of an online game, a console-based game, a browser-based game, a cloud-based game, a mobile-based game, or a tablet-based game. In an embodiment, the second application may be a multimedia application or a web application.

In an embodiment, the set of metadata may include one or more of a title captured from the first multimedia content, an artist captured from the first multimedia content, an album captured from the first multimedia content, a year of release of multimedia content captured from the first multimedia content, and/or a user rating corresponding to the first multimedia content.

In an embodiment, the received first plurality of user preferences may include a set of input parameters provided by the user, and/or a user profile of the user. In an embodiment, the set of input parameters may include one or more of: beats per minute (BPM) of the second multimedia content, mood of the user, a desired genre of the second multimedia content, a year range of the second multimedia content, a running time of the second multimedia content, one or more keywords related to the second multimedia content, a biometric input, and/or an identification of the second multimedia content

In an embodiment, the user profile of the user may include one or more of: preferences of a specific multimedia content based on a numerical value or a graphical indication, multimedia content consumption behavior of the user, viewing or listening history of the user, subscription details of the user, multimedia purchases, favorite multimedia content, or demographic details of the user.

In an embodiment, the method may include correlating the set of metadata, the set of input parameters, and/or the user profile of the user associated with the first electronic device during execution of the first application. In an embodiment, the method may include determining the second multimedia content based on the correlation. In an embodiment, the recommended second multimedia content may be a promotional multimedia content.

In an embodiment, the method may include recommending the second multimedia content to the second application through the multimedia distribution channel. The user may be associated with the first electronic device during execution of the second application.

In an embodiment, the method may include recommending the second multimedia content to another application executed by the second electronic device through the multimedia distribution channel. The second electronic device may be communicably coupled to the server. The user may be associated with the second electronic device during execution of another application. In an embodiment, the method may include receiving a second plurality of user preferences based on the recommended second multimedia content. In an embodiment, the method may include determining third multimedia content based on the first plurality of user preferences and the second plurality of user preferences.

In an embodiment, the user may be associated with the first electronic device during the execution of the first application and the second application.

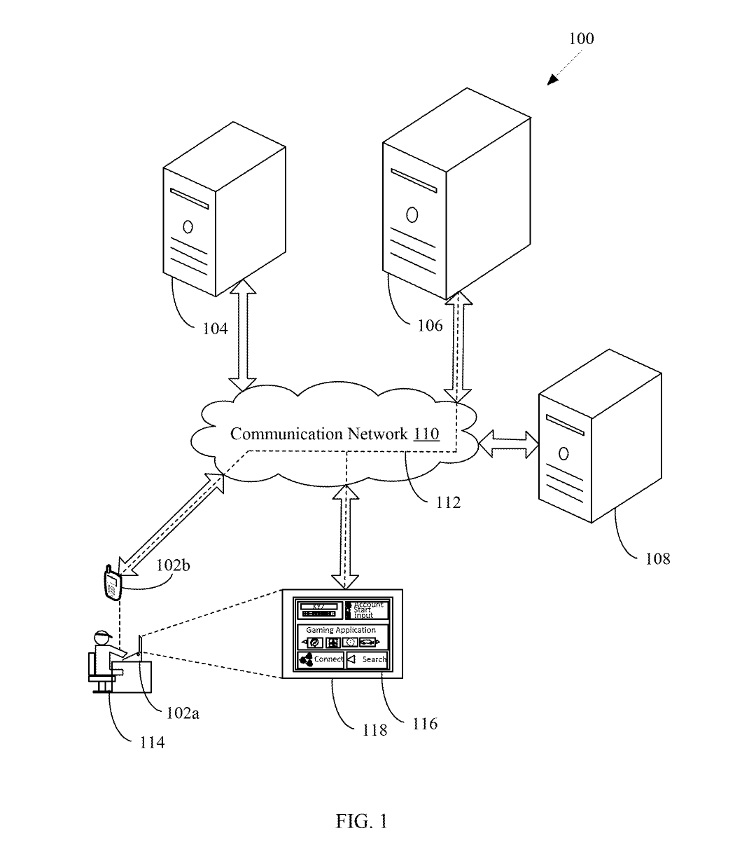

FIG. 1 is a block diagram illustrating a network environment, in accordance with an embodiment of the disclosure. With reference to FIG. 1, there is shown a network environment 100. The network environment 100 may include a plurality of electronic devices, for example, a first electronic device 102a and a second electronic device 102b, an online application server 104, a multimedia server 106, a social networking server 108, and a communication network 110. The communication network 110 may facilitate a multimedia distribution channel 112. Although FIG. 1 shows only the first electronic device 102a and the second electronic device 102b associated with the user 114 for simplicity, one skilled in the art may appreciate that the disclosed embodiments can be implemented for a larger number of electronic devices and associated users in the network environment 100.

The first electronic device 102a and the second electronic device 102b may include suitable logic, circuitry, interfaces, and/or code that may be operable to receive an input from the user 114 and render an output to the user 114. Examples of the first electronic device 102a and the second electronic device 102b may include, but are not limited to, laptops, tablet computers, smartphones, and Personal Digital Assistant (PDA) devices.

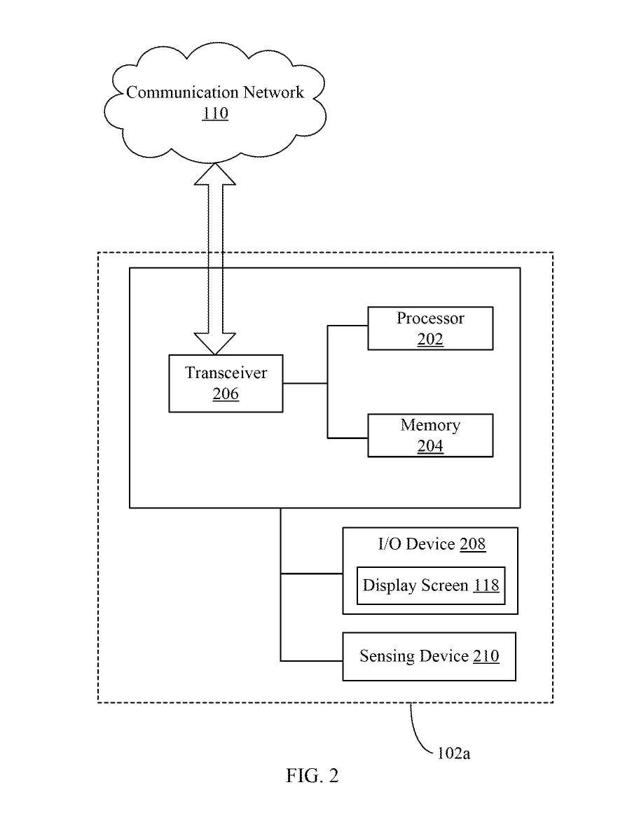

In an embodiment, the first electronic device 102a may be operable to execute a first application via an interface 116 displayed on a display screen 118 of the first electronic device 102a. In an embodiment, the first electronic device 102a may also be operable to execute a second application via the interface (not shown) displayed on a display screen 118 of the first electronic device 102a. In an embodiment, the second electronic device 102b may execute another application via a second interface displayed on a display screen (not shown) of the second electronic device 102b. Although the first electronic device 102a and the second electronic device 102b may have similar logic, circuitry, interfaces, and/or code, only the first electronic device 102a is described in further detail in FIG. 2 for brevity. The online application server 104 may comprise suitable logic, circuitry, interfaces, and/or code that may be operable to host web-based applications for the user 114. Examples of the web-based applications may include, but are not limited to, webmail, online retail sales, online auctions, wikis, audio-visual conferences, multi-player games, live video sessions, live chat sessions and/or the like. Such web-based applications may be reliant on a common web browser to execute the online application hosted by the online application server 104.

In an embodiment, the online application server 104 may be operable to host and stream an online application, for example, an online single-player or multi-player gaming application, to the first electronic device 102a, in accordance with an embodiment of the disclosure. Examples of such an online gaming application may include, but are not limited to, a console-based game, a browser-based game, a cloud-based game, a mobile-based game, or a tablet-based game. Such an online application may be reliant on a common web browser, for example, the interface 116 displayed on the display screen 118 of the first electronic device 102a. It will be appreciated by those skilled in the art that any localized (hereafter, referred to as offline) or centralized (hereafter, referred to as online) gaming application may be executed on the first electronic device 102a without deviating from the scope of the disclosure. Examples of the online application server 104 may include, but are not limited to, Sun Java Application Server®, Weblogic Server®, Apache Geronimo®, Bea Weblogic®, and/or IBM WebSphere®.

The multimedia server 106 may comprise suitable logic, circuitry, interfaces, and/or code that facilitates streaming of multimedia content to the first electronic device 102a and the second electronic device 102b via the communication network 110. In an embodiment, the multimedia server 106 may be implemented as a part of a server cloud. The multimedia server 106 may be accessed and managed by a third party.

The multimedia server 106 may be configured to organize and manage a large multimedia collection, for example, digital videos, movies, audio, music, and/or picture files. The multimedia server 106 may be further configured to serve multimedia-on-demand to a requesting device, for example, the first electronic device 102a. In an embodiment, the multimedia server 106 may be a simple network-attached storage, for example, a Home Theater Personal Computer (HTPC) running Windows XP Media Center Edition®. In an embodiment, the multimedia server 106 may be a commercial web server that may host multimedia for a large web site. Examples of such a commercial multimedia server may include, but are not limited to, Sony's Gigajuke Music Server®, Mcrew®, MediaPortal®, MythTV®, Sun Music®, Sonata®, Olive 4HD®, NuVo Technologies Music Port®, and/or Escient Fireball SE-80 Digital Music Manager®.

The social networking server 108 may comprise suitable logic, circuitry, interfaces, and/or code that may be operable to host at least one social networking website, such as Facebook®, Google+®, tumblr®, Twitter® and/or MySpace®, to provide social networking services to the user 114. Notwithstanding, the disclosure may not be so limited, and other social networking websites may be hosted without limiting the scope of the disclosure.

The communication network 110 may include a medium through which the first electronic device 102a and the second electronic device 102b may communicate with the online application server 104, the multimedia server 106, and the social networking server 108. Examples of the communication network 110 may include, but are not limited to, the Internet, a Wireless Fidelity (Wi-Fi) network, a Wireless Local Area Network (WLAN), a Local Area Network (LAN), a telephone line (POTS), and/or a Metropolitan Area Network (MAN). The first electronic device 102a, the second electronic device 102b, the online application server 104, the multimedia server 106, and the social networking server 108 in the network environment 100 may be operable to communicate via the communication network 110, in accordance with various wired and wireless communication protocols, such as, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

The multimedia distribution channel 112 of the communication network 110 may be an Internet-based multimedia service that may provide a multimedia access to the multimedia server 106 by the user 114. The multimedia server 106 may recommend multimedia content to the user 114 through the multimedia distribution channel 112. The multimedia content may be distributed via the multimedia distribution channel 112 to the first electronic device 102a and/or the second electronic device 102b, associated with the user 114. The multimedia distribution channel 112 may also facilitate buffering of the multimedia content streamed from the multimedia server 106 at the first electronic device 102a and/or the second electronic device 102b. In an embodiment, the multimedia server 106 may stream the multimedia content to the user 114 through the multimedia distribution channel 112, for example, an IPTV unicast stream, based on the received first plurality of user preferences.

The user 114 may operate the first electronic device 102a and/or the second electronic device 102b as a system administrator. In an embodiment, the user 114 may be an owner of the first electronic device 102a and/or the second electronic device 102b. In an embodiment, the user 114 may configure a personal computing environment that may include the first electronic device 102a and/or the second electronic device 102b.

In an embodiment, the user 114 may connect to one or more other users in the network environment 100, via the social networking website hosted by the social networking server 108. Based on an online user profile of the user 114, a social network of the user 114 may be determined by the social networking server 108. Such a user profile of the user 114 may include personal details of the user 114, professional details of the user 114, the one or more other users in a friend list of the user 114, an update associated with the social network of the user 114, information about social gatherings related to the user 114, and other information (such as an image, a comment, and the like) posted by the one or more other users socially connected to the user 114.

The interface 116 may be a graphical user interface (GUI) that may be presented on the first electronic device 102a and/or the second electronic device 102b. The interface 116 may enable the user 114 to access, retrieve, view, and/or execute applications hosted by a plurality of application servers, for example, the online application server 104 and the multimedia server 106. In an embodiment, the interface 116 may further enable the user 114 to access, retrieve, view, and/or execute offline applications stored in a local memory of the first electronic device 102a and/or the second electronic device 102b.

In an embodiment, the user 114 may install a software application (not shown) on the first electronic device 102a and/or the second electronic device 102b, to present the interface 116. Examples of the software application may include, but are not limited to, Internet Explorer®, Mozilla Firefox® and the like.

In operation, the multimedia server 106 may be communicatively coupled to the first electronic device 102a. The first electronic device 102a may be operable to execute a first application and a second application. The multimedia server 106 may receive a first plurality of user preferences, while the first electronic device 102a executes the first application. The first plurality of user preferences may include a set of metadata, a set of input parameters, and/or a user profile of the user 114. The set of metadata may correspond to a first multimedia content rendered during the execution of the first application at the first electronic device 102a.

The multimedia server 106 may determine second multimedia content based on a correlation of the received set of metadata, the set of input parameters, and/or the user profile of the user 114. The multimedia server 106 may recommend the determined multimedia content to the user 114. The multimedia server 106 may stream the recommended multimedia content to the first electronic device 102a, while the first electronic device 102a executes a second application. The multimedia server 106 may stream the recommended multimedia content to the first electronic device 102a, through the multimedia distribution channel 112. In an embodiment, the multimedia server 106 may stream the recommended multimedia content to a second electronic device 102b, associated with the user 114, through the multimedia distribution channel 112. The second electronic device 102b may receive the recommended multimedia content, during an execution of another application.

In an embodiment, the user 114, associated with the first electronic device 102a, may provide a part of a first plurality of user preferences, for example, a set of input parameters, during the execution of the first application. The multimedia server 106 may receive the user profile of the user 114 directly from the social networking server 108. In another embodiment, the multimedia server 106 may receive the user profile of the user 114 from the first electronic device 102a. In such an embodiment, the first electronic device 102a may receive the user profile of the user 114 from the social networking server 108. It may be appreciated that such a user profile of the user 114 may be dynamically updated based upon an activity, a modification, and/or a selection performed by the user 114.

In an embodiment, the first electronic device 102a may receive the second multimedia content, recommended and streamed by the multimedia server 106, and store in a multimedia library associated with the second application, executed at the first electronic device 102a.

In another embodiment, the multimedia server 106 may be operable to receive a second plurality of user preferences from the user 114. The user 114 may be associated with the first electronic device 102a, while the first electronic device 102a executes the second application.

In another embodiment, the multimedia server 106 may be operable to determine third multimedia content to the user 114, based on a correlation of the first plurality of user preferences and/or the second plurality of user preferences. The multimedia server 106 may be operable to recommend and stream the determined third multimedia content to the user 114, through the multimedia distribution channel 112. The third multimedia content may be streamed to any application executing at any electronic device.

FIG. 2 is a block diagram illustrating an electronic device, in accordance with an embodiment of the disclosure. FIG. 2 is explained in conjunction with elements from FIG. 1. With reference to FIG. 2, there is shown the first electronic device 102a. The first electronic device 102a may include one or more processors, such as a processor 202, a memory 204, a transceiver 206, one or more Input-Output (I/O) devices, such as an I/O device 208, and one or more sensing devices, such as a sensing device 210.

The processor 202 may be communicatively coupled to the memory 204, and the I/O device 208. Further, the transceiver 206 may be communicatively coupled to the processor 202, the memory 204, the I/O device 208, and the sensing device 210.

The processor 202 may comprise suitable logic, circuitry, interfaces, and/or code that may be operable to execute a set of instructions stored in the memory 204. The processor 202 may be implemented based on a number of processor technologies known in the art. Examples of processor 202 may be an X86-based processor, a Reduced Instruction Set Computing (RISC) processor, an Application-Specific Integrated Circuit (ASIC) processor, a Complex Instruction Set Computing (CISC) processor, or any other processor.

The memory 204 may comprise suitable logic, circuitry, interfaces, and/or code that may be operable to store the received set of instructions. The memory 204 may be implemented based on, but not limited to, a Random Access Memory (RAM), a Read-Only Memory (ROM), a Hard Disk Drive (HDD), a storage server and/or a Secure Digital (SD) card.

The memory 204 may further include a multimedia data-store operable to store a repository that may include one or more multimedia content, for example the first multimedia content, the second multimedia content, and the recommended multimedia content received from the multimedia server 106. The multimedia data-store may be further operable to store one or more multimedia libraries associated with one or more applications executed by the first electronic device 102a. The multimedia data-store may be implemented by using various multimedia database management systems that are well known to those skilled in the art. Some examples of multimedia database management systems may include, but are not limited to, VisualSEEK®, Informedia® and/or VideoQ®.

The transceiver 206 may comprise suitable logic, circuitry, interfaces, and/or code that may be operable to communicate with the online application server 104, the multimedia server 106, and the social networking server 108 via various communication interfaces. The transceiver 206 may implement known technologies for supporting wired or wireless communication with the communication network 110. The transceiver 206 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a memory. The transceiver 206 may communicate via wireless communication with networks, such as the Internet, an Intranet and/or a wireless network, such as a cellular telephone network, a wireless local area network (LAN) and/or a metropolitan area network (MAN), and other devices. The wireless communication may use any of a plurality of communication standards, protocols and technologies including, but not limited to, Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The I/O device 208 may comprise various input and output devices that may be operable to connect to the processor 202. Examples of the input devices may include, but are not limited to, a keyboard, a mouse, a joystick, a touch screen, a microphone, a camera, a motion sensor, a light sensor, and/or a docking station. Examples of the output devices may include, but are not limited to, the display screen 118, and/or a speaker.

The sensing device 210 may comprise suitable logic, circuitry, and/or interfaces that may be operable to store a machine code and/or a computer program having at least one code section executable by the processor 202 to receive and respond to a signal when touched or activated. Such a signal may be based on a touch-based input, a touch-less input and/or a voice-based input. In an embodiment, the sensing device 210 may include one or more sensors operable to receive the touch-based input, the touch-less input and/or the voice-based input. In another embodiment, the one or more sensors may include a camera to detect at least one of the following for retrieving biometric data of the user 114, for example two or three-dimensional facial expressions, and characteristic features of the iris. In another embodiment, the one or more sensors may include a microphone operable to detect a voice pattern of the user 114.

The sensing device 210 may implement various known biometric algorithms for retrieving biometric data of the user 114. Examples of such biometric algorithms may include, but are not limited to, algorithms for face recognition, voice recognition, and iris recognition. It will be appreciated by those skilled in the art that any unique characteristic of the user may be accepted as a biometric input within the ongoing context.

In operation, the processor 202 of the first electronic device 102a, communicatively coupled to the online application server 104 and the multimedia server 106, may be operable to execute a first application. The processor 202 may be operable to receive at least a part of a first plurality of user preferences from the user during an execution of the first application. The processor 202 may transmit the first plurality of user preferences to the multimedia server 106. The first plurality of user preferences may include a set of metadata corresponding to a first multimedia content rendered during the execution of the first application at the first electronic device 102a.

The processor 202 may be operable to receive a second multimedia content, based on the first plurality of user preferences, streamed by the multimedia server 106 during the execution of the second application. The processor 202 may be operable to store the received second multimedia content in a multimedia library associated with the second application being executed at the first electronic device 102a.

In an embodiment, the processor 202 may be operable to transmit a second plurality of user preferences corresponding to the second multimedia content being rendered during the execution of the second application at the first electronic device 102a. Accordingly, the user 114 associated with the first electronic device 102a may receive a third multimedia content, recommended and streamed by the multimedia server 106. In an embodiment, the multimedia server 106 may recommend the third multimedia content based on a correlation of the first plurality of user preferences and/or the second plurality of user preferences provided by the user 114. The processor 202 may be operable to receive the recommended third multimedia content, streamed by the multimedia server 106. The processor 202 may be operable to store the received third multimedia content in a multimedia library associated with the second application being executed at the first electronic device 102a.

In an embodiment, the first application may be an offline application. Such an offline application may be connected to the online application server 104 and/or the multimedia server 106 during or after the execution based on the connectivity of the first electronic device 102a to the communication network 110. In an embodiment, the communication network 110 may not be available during the execution of the first application. In such an embodiment, the first plurality of user preferences may be transmitted to the multimedia server 106 whenever the communication network 110 is next available to the first electronic device 102a. In such an embodiment, the first plurality of user preferences may be stored in the memory 204 of the first electronic device 102a for later use.

In an embodiment, the offline application may be stored locally in a secondary storage device, for example, the hard disk which corresponds to the memory 204 of first electronic device 102a. Examples of such an offline application may include, but are not limited to, a console-based game, a mobile-based game, or a table-based game. In an embodiment, the offline application may be rendered using a secondary storage device, for example, a hard disk of the first electronic device 102a. In an embodiment, the offline application may be rendered using an external storage device, for example, a compact disc (CD), a digital versatile disc (DVD), a solid state storage, and/or a flash memory externally connected with the memory 204 of first electronic device 102a.

In an embodiment, the first application which executes on the first electronic device 102a may be an online application. Such an online application may be hosted by the online application server 104, communicably coupled to the first electronic device 102a, via the communication network 110 and the transceiver 206. Examples of such an online application may include, but are not limited to, an online game, a browser-based game, a cloud-based game, a distributed shared game, and/or an online multiplayer game.

In an embodiment, the processor 202 may be operable to render a first multimedia content on the display screen 118 during execution of the first application at the first electronic device 102a. The first multimedia content may be rendered based on the user profile of the user 114, associated with the first electronic device 102a, while the first electronic device 102a executes the first application. In another embodiment, the first multimedia content may be pre-packaged by an application developer with the first application.

In an embodiment, the first multimedia content may be an audio content that may be streamed by the multimedia server 106. The audio content may be streamed live from an Internet radio station via the Internet. The Internet radio station may transmit the audio content continuously, streamed serially over the local network or Internet in TCP or UDP packets. Such TCP or UDP packets may be reassembled at the first electronic device 102a and played after a pre-defined delay. Examples of the Internet radio stations may include, but are not limited to, CBS Radio® and/or Citadel Broadcasting®.

In an embodiment, the first multimedia content may be an audio-visual content streamed by the multimedia server 106. The multimedia server 106 may correlate a set of metadata corresponding to the first multimedia content, the set of input parameters provided by the user 114, and/or the user profile of the user 114 associated with the first electronic device 102a, while the first electronic device 102a executes the first application. Examples of the multimedia server 106 streaming the audio-visual content include, but are not limited to, Macromedia Communication Server®, and/or MediaPortal®.

In an embodiment, the first multimedia content may be automatically selected from a pre-defined set of multimedia content, based on a genre of the application. For example, in the case of a video card game, such as Free Cell™, the first multimedia content may be a slow and soothing music. In another example, in the case of an action game, such as Counter Strike™, the first multimedia content may be hard-rock music.

In an embodiment, the first multimedia content may be inbuilt and a part of the first application and may not be streamed from any server. In another embodiment, for an offline application, the processor 202 may be operable to select the first multimedia content from a pre-defined set of multimedia content. The pre-defined set of multimedia content may be pre-stored in the secondary storage device or the external storage device associated with the memory 204.

In an embodiment, for the online application, the processor 202 may be operable to select the first multimedia content from a pre-defined set of multimedia content pre-stored in the multimedia server 106. In another embodiment, for the online application, the processor 202 may select the first multimedia content from a pre-defined set of multimedia content pre-stored in the multimedia server 106 based on generic user preferences of the user 114, for example, the user profile of the user 114 stored at one or more online servers or in the memory 204 of the first electronic device 102a. Notwithstanding, the disclosure may not be so limited, and other multimedia servers, for example, MinimServer®, may be utilized for selection of the first multimedia content, without limiting the scope of the disclosure.

In an embodiment, the first multimedia content may be streamed from an Internet radio station via the Internet. In another embodiment, the processor 202 may be operable to select the first multimedia content from a pre-defined set of multimedia content based on a genre of the first application.

In an embodiment, the processor 202 may be operable to receive the first plurality of user preferences, during the execution of the first application. The first plurality of user preferences may include a set of metadata corresponding to the first multimedia content, rendered at the first electronic device 102a. In an embodiment, the first plurality of user preferences may further include a set of input parameters, and/or a user profile of the user 114, in addition to the set of metadata. The processor 202 may be operable to receive a part of the first plurality of user preferences from the user 114, associated with the first electronic device 102a during the execution of the first application.

In an embodiment, the processor 202 may be operable to determine the set of metadata, corresponding to the first multimedia content (rendered during execution of the first application at the first electronic device 102a). Such a set of metadata, may include, but is not limited to, a title captured from the first multimedia content, a name of an artist captured from the first multimedia content, a name of an album captured from the first multimedia content, a year of release of the multimedia content captured the first multimedia content, and/or a user rating, which corresponds to the first multimedia content.

In an embodiment, the processor 202 may be operable to enable the user 114 to rate the first multimedia content rendered on the first electronic device 102a. In an embodiment, Such a rating may be provided by the user 114, using alpha-numeric values. For example, a rating of the multimedia content may be taken on a scale of 0 and 1, where 1 indicates appreciation and 0 indicates dislike of the multimedia content. In another example, on a scale of 1 to 5, where 5 indicates greatest appreciation, 4 indicates above-average appreciation, 3 indicates an average appreciation, 2 indicates dislike, 1 indicates below-average dislike of the multimedia content, and 0 indicates no opinion at all. In an embodiment, such a rating may be provided by the user 114, based on a selection of graphical icons, for example, selection of “thumbs-up” icon indicating appreciation of the multimedia content and selection of “thumbs-down” icon for dislike of the multimedia content. In another example, the rating may be provided or selected by the user 114 in an alpha-numeric format. Such a rating provided by the user 114 for the first or second multimedia content may be stored in the set of metadata corresponding to the first or second multimedia content.

In an embodiment, the processor 202 may be operable to receive the set of input parameters, provided by the user 114, during the execution of the first application at the first electronic device 102a. Such input parameters may correspond to beats per minute (BPM) of the second multimedia content, mood of the user 114, a desired genre of the second multimedia content, a year range of the second multimedia content, a running time of the second multimedia content, one or more keywords related to the second multimedia content, and/or an identification of the second multimedia content.

In an embodiment, the set of input parameters may be provided by the user 114 based on a pre-defined stage of the first application. For example, the user 114 may select and assign an audio multimedia content ‘Mysterious Ways . . . ’ for a ‘Gaming Level—4’ of an online gaming application ‘Treasure Hunt—Hidden Treasures of the Mysterious Sea’.

The user 114 may provide values of the set of input parameters for desired second multimedia content, using the I/O device 208. Such values may be provided by the user 114 based on a touch input, a touch-less input and/or a speech input via the I/O device 208.

In an embodiment, the touch input may include touch gestures on one or more hardware buttons or the touch screen of the first electronic device 102a. The touch-less input may include a set of touch-less gestures on a pre-defined proximity of the first electronic device 102a. The set of touch-less gestures may include a hand gesture, a finger gesture, a facial gesture and/or a body gesture. In an embodiment, the speech input may include a voice pattern of the user 114.

In an embodiment, the processor 202 may be operable to receive the user profile of the user 114, associated with the first electronic device 102a, while the first electronic device 102a executes the first application. The user profile of the user 114 may be a digital representation of the user's identity, characteristics, and/or preferences. Examples of the user profile may include, but are not limited to, a preference of a specific multimedia content based on an alpha-numerical value or a graphical indication, a geographical location of the user 114, multimedia content consumption behavior, viewing or listening history, multimedia subscription details, multimedia purchases, favorite multimedia content, and/or demographic details of the user 114.

In an embodiment, the processor 202 may be operable to determine the user profile from subscription and profile details from an account of the user 114, which may be stored in the one or more servers, for example, the online application server 104, and/or the social networking server 108. In an embodiment, the user profile may be determined from the subscription and profile details stored in the memory 204 of the first electronic device 102a. For example, the multimedia server 106 may be configured to provide subscription-based multimedia services, for example, Sony Music Unlimited®, Rhapsody®, iTunes®, Plex®, MusicStation®, Napster®, Xbox Music®, and/or the like to the user 114. In such a case, the processor 202 may be operable to determine a part of the user profile of the user 114 stored in the memory 204 of the first electronic device 102a.

In an embodiment, the processor 202 may be operable to transmit the first plurality of user preferences to the multimedia server 106, via the transceiver 206. The processor 202 may be operable to receive a second multimedia content, recommended and streamed by the multimedia server 106. The second multimedia content may be received by the processor 202, via the multimedia distribution channel 112 and the transceiver 206.

In an embodiment, the processor 202 may be operable to receive the second multimedia content, recommended and streamed by the multimedia server 106, while the first electronic device 102a executes the first application. In such an embodiment, the processor 202 may be operable to store the received second multimedia content in a multimedia library associated with the first application being executed at the first electronic device 102a.

In an embodiment, the processor 202 may be operable to receive the second multimedia content, recommended and streamed by the multimedia server 106, while the first electronic device 102a executes the second application. In such an embodiment, the processor 202 may be operable to store the received second multimedia content in a multimedia library associated with the second application being executed at the first electronic device 102a.

In an embodiment, the second application may be a multimedia application or a web application. Such a second application may be an online application or an offline application. Examples of the second application may include, but are not limited to, an offline or online gaming application, SonyLIV®, Google Docs®, Meebo®, TokBox®, Splashup®, Flash Player® and/or Quicktime®.

In an embodiment, the second multimedia content may be a promotional multimedia content and may not be present in a multimedia library associated with the first application or the second application. Such a second multimedia content may include multimedia content that is intended for official marketing and endorsement of multimedia content, for example, music promos, video clips, and the like. The user 114 may not be familiar with the determined multimedia content as the determined multimedia content may be a new release and may not have been broadcasted previously. For example, the user 114, associated with the first electronic device executing the first application, while playing Sony PlayStation®, may receive a recently released song, titled ‘Dreams Coming True’, as the second multimedia content during execution of the first application at the first electronic device 102a.

In an embodiment, the user 114 may receive the recently released music track as the second multimedia content during execution of the second application, for example, working on a word document, at the first electronic device 102a based on the first plurality of user preferences associated with the first multimedia content (another recently released song). The user 114 may receive the recently released song as the second multimedia content during execution of another application, for example, while viewing web album in Picasa®, at the second electronic device 102b.

In an embodiment, the processor 202 may be operable to enable the user 114 to rate the second multimedia content rendered on the first electronic device 102a. Such a rating provided by the user 114 for the second multimedia content may be stored in another set of metadata corresponding to the second multimedia content. Such another set of metadata may be included in a second plurality of user preferences corresponding to the second multimedia content.

In an embodiment, the processor 202 may be operable to transmit the second plurality of user preferences to the multimedia server. Accordingly, the processor 202 may be operable to receive the third multimedia content, recommended and streamed by the multimedia server 106. The multimedia server 106 may recommend third multimedia content based on a correlation of the first plurality of user preferences and/or the second plurality of user preferences provided by the user 114. The processor 202 may be operable to store the received third multimedia content in a multimedia library associated with the second application being executed at the first electronic device 102a.

In an embodiment, the user 114 may suggest the first multimedia content and the second multimedia content to one or more other users that may be socially connected to the user 114 via the social network. The first electronic device 102a may include a social networking application through which the user 114 may communicate with the social networking server 108. In an embodiment, the user 114 may use the social networking application to browse one or more web pages of a social networking website, hosted by the social networking server 108. For example, through the first electronic device 102a, the user 114 may perform various activities, such as post comments on the social networking website, view images uploaded by other users on the social networking website, and read reviews about multimedia products and/or services.

In an embodiment, the processor 202 may enable the user 114 to suggest the first multimedia content, the second multimedia content, and the third multimedia content to one or more other users that are socially connected to the user 114 via a social network. The one or more other users are determined by the social networking server 108, based on one or more similar parameters between the user 114 to the one or more other users in the social network. Such a determination may be based on one or more parameters such as, an area of interest, an activity of interest, an event, educational background, a professional background, a relation, and/or a social network connection. Notwithstanding, the disclosure may not be so limited, and other parameters may be utilized without limiting the scope of the disclosure.

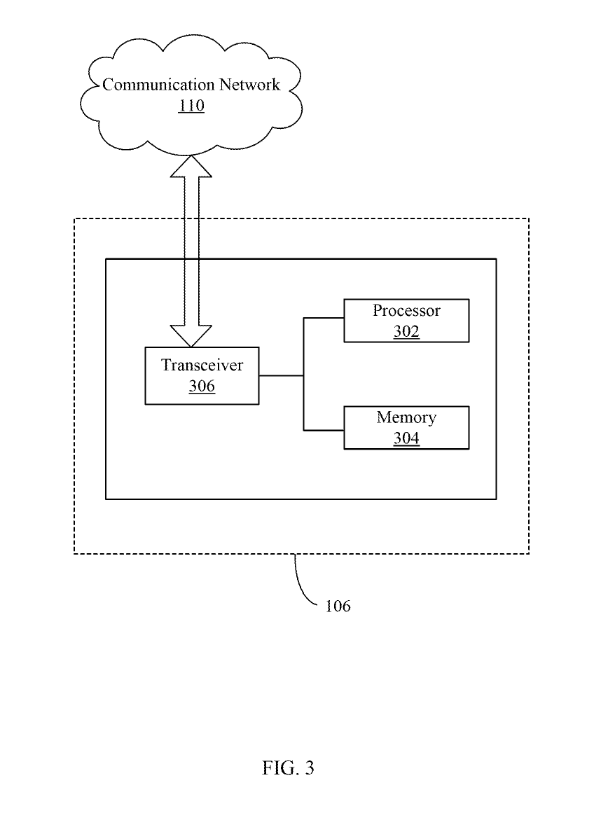

FIG. 3 is a block diagram illustrating a multimedia server, in accordance with an embodiment of the disclosure. FIG. 3 is explained in conjunction with elements from FIG. 1. With reference to FIG. 3, there is shown the multimedia server 106. The multimedia server 106 may include one or more processors, such as a processor 302, a memory 304, and a transceiver 306.

The processor 302 may be communicatively coupled to the memory 304. Further, the transceiver 306 may be communicatively coupled to the processor 302 and the memory 304.

The processor 302 may comprise suitable logic, circuitry, interfaces, and/or code that may be operable to execute a set of instructions stored in the memory 304. The processor 302 may be implemented based on a number of processor technologies known in the art. Examples of processor 302 may be an X86-based processor, a Reduced Instruction Set Computing (RISC) processor, an Application-Specific Integrated Circuit (ASIC) processor, a Complex Instruction Set Computing (CISC) processor, or any other processor.

The memory 304 may comprise suitable logic, circuitry, interfaces, and/or code that may be operable to store the received set of instructions. The memory 304 may be implemented based on, but not limited to, a Random Access Memory (RAM), a Read-Only Memory (ROM), a Hard Disk Drive (HDD), a storage server and/or a Secure Digital (SD) card.

The transceiver 306 may comprise suitable logic, circuitry, interfaces, and/or code that may be operable to communicate with the first electronic device 102a, the online application server 104, and the social networking server 108 via different communication interfaces. The transceiver 306 may implement known technologies for supporting wired or wireless communication with the communication network 110. The transceiver 306 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a memory. The transceiver 306 may communicate via wireless communication with networks, such as the Internet, and/or a wireless network, such as a cellular telephone network, a wireless local area network (LAN) and/or a metropolitan area network (MAN), and other devices. The wireless communication may use any of a plurality of communication standards, protocols and technologies including, but not limited to, Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

In operation, the processor 302 may be operable to receive the first plurality of user preferences from the first electronic device 102a, while the first electronic device 102a executes the first application. The first plurality of user preferences may include a set of metadata and may correspond to a first multimedia content rendered during the execution of the first application at the first electronic device 102a. The first plurality of user preferences may further include a set of input parameters, and/or a user profile of the user 114, in addition to the set of metadata.

The processor 302 may be operable to correlate the set of metadata, the set of input parameters and/or the user profile of the user 114 associated with the first electronic device 102a during execution of the first application. The processor 302 may be operable to determine a second multimedia content based on the correlation of the set of metadata, the set of input parameters, and the user profile of the user 114. Based on the determination, the processor 302 may be operable to recommend the second multimedia content to the user 114. In an embodiment, the second multimedia content may be streamed to the first electronic device 102a associated with the user 114, via the multimedia distribution channel 112. In an embodiment, the second multimedia content may be streamed to the second electronic device 102b associated with the user 114, via the multimedia distribution channel 112.

The processor 302 may be further operable to receive a second plurality of user preferences from the first electronic device 102a, while the first electronic device 102a executes the second application. The second plurality of user preferences may include another set of metadata may correspond to a second multimedia content rendered during the execution of the second application at the first electronic device 102a. The second plurality of user preferences may further include another set of input parameters, and/or an updated user profile of the user 114, in addition to another set of metadata.

Although FIG. 3 only describes a communication between the processor 302 and the first electronic device 102a associated with the user 114, one skilled in the art may appreciate that the disclosed embodiments can be implemented for any electronic device, for example the second electronic device 102b, associated with the user 114.

In an embodiment, the processor 302 may be operable to determine a part of the first plurality of user preferences, for example the set of metadata, from the first multimedia content rendered during the execution of the first application at the first electronic device 102a.

In another embodiment, the processor 302 may be operable to determine a part of the first plurality of user preferences, for example, the user profile, from the subscription and profile details of an account of the user 114, stored in the memory 304 of the multimedia server 106. In an embodiment, the processor 302 may be operable to receive another part of the first plurality of user preferences, for example, the user profile, from the subscription and profile details of an account of the user 114 stored in the memory of the online application server 104, or the memory (not shown) of the social networking server 108. In an embodiment, the processor 302 may be operable to receive another part of the first plurality of user preferences, for example, the user profile, from the subscription and profile details stored in the memory 204 of the first electronic device 102a. In an embodiment, the processor 302 may be operable to receive another part of the first plurality of user preferences, for example, the set of input parameters, from the user 114 associated with the first electronic device 102a.

In an embodiment, the processor 302 may be operable to correlate the set of metadata, the set of input parameters and/or the user profile of the user 114 associated with the first electronic device 102a during execution of the first application. In an embodiment, the processor 302 may be operable to correlate the set of metadata, the set of input parameters, and/or the user profile of the user 114 associated with the first electronic device 102a during execution of the second application. In an embodiment, the processor 302 may be operable to correlate the set of metadata, the set of input parameters, and/or the user profile of the user 114 associated with the second electronic device 102b during execution of another application.

In an embodiment, the processor 302 may be operable to correlate the set of metadata, the set of input parameters and/or the user profile of the user 114 based on a set of common parameters. The processor 302 may be operable to determine a second multimedia content based on the correlation of the set of metadata, the set of input parameters, and the user profile of the user 114. For example, the set of metadata may include a new release titled ‘Dreams Coming True’ by a famous artist ‘John Z.’. The user profile of the user 114 may include the listening history of the user indicating a preference for an artist ‘John Z.’. The set of input parameters may also include a keyword ‘John Z.’ provided by the user 114. The processor 302 may correlate the set of metadata, the set of input parameters and/or the user profile of the user 114 based on a set of common parameters, such as the artist ‘John Z.’. Thus, the processor 302 may be operable to determine that the new release titled ‘Dreams Coming True’ by the artist ‘John Z.’ may be the second multimedia content.

In an embodiment, the second multimedia content, for example, the song titled ‘Dreams Coming True’, may be a promotional multimedia content and may not be present in a multimedia library associated with the first application, second application or another application. Such a second multimedia content may include multimedia that is intended for official marketing and endorsement of multimedia content, for example, music promotions, video clips, and the like. In an embodiment, the user 114 may not be familiar with the second multimedia content as the determined multimedia content may be a new release and may not have been broadcasted previously.

In an embodiment, the processor 302 may be operable to recommend the second multimedia content, for example, the song titled ‘Dreams Coming True’, determined by the processor 302, to the user 114. In an embodiment, the user may be associated with the first electronic device 102a, while the first electronic device 102a executes the first application or the second application. In an embodiment, the user may be associated with the second electronic device 102b, while the second electronic device 102b executes another application.

For example, the user 114 via a laptop executing a game, may provide the first plurality of preferences to the processor 302. The processor 302 may determine the second multimedia content, for example, the song titled ‘Dreams Coming True’, based on the first plurality of preferences, and stream the second multimedia content to the user 114. Meanwhile or at a later time, the user may start executing another application at the second electronic device 102b. The second multimedia content may be received and rendered by the second electronic device 102b via the second application. In other words, the user 114, now associated with the second electronic device 102b, may listen to the song titled ‘Dreams Coming True’ or another similar song.

In an embodiment, the processor 302 may be operable to actively recommend the second multimedia content to the user 114. An active recommendation of the second multimedia content may correspond to multimedia content recommended directly by the multimedia server 106, based on the user profile and the set of input parameters provided by the user 114. The user profile may be received from one or more online servers and/or the first electronic device 102a.

In another embodiment, the processor 302 may be operable to passively recommend multimedia content to the user 114. A passive recommendation of the second multimedia content may correspond to multimedia content recommended indirectly by the multimedia server 106, based on a set of metadata, and/or the set of input parameters and the user profile provided by the user 114. Such a set of metadata may be determined by the first electronic device 102a and/or the multimedia server 106.

In an embodiment, the processor 302 may be operable to stream the second multimedia content recommended by the processor 302, to the first electronic device 102a, while the first electronic device 102a executes the first application. In an embodiment, the processor 302 may be operable to stream the second multimedia content recommended by the processor 302, to the first electronic device 102a, while the first electronic device 102a executes the second application. In an embodiment, the processor 302 may stream the second multimedia content recommended by the processor 302, to the second electronic device 102b, while the second electronic device 102b executes another application.

In an embodiment, the processor 302 may be operable to stream the second multimedia content to the first electronic device 102a and/or the second electronic device 102b associated with the user 114, via the multimedia distribution channel 112 using the transceiver 306.

In an embodiment, the processor 302 may be operable to receive a second plurality of user preferences based on the second multimedia content being rendered during the execution of the first application or the second application at the first electronic device 102a. In an embodiment, the processor 302 of the multimedia server 106 may be operable to receive a second plurality of user preferences based on the second multimedia content being rendered during the execution of another application at the second electronic device 102b.

In an embodiment, the processor 302 may be operable to correlate the first plurality of user preferences and the second plurality of user preferences to determine third multimedia content. In an embodiment, the processor 302 may recommend the determined third multimedia content to the user 114. In an embodiment, the processor 302 may be operable to stream the recommended third multimedia content to any electronic device associated with the user 114, through the multimedia distribution channel 112.

Based on the correlation, the processor 302 may be operable to determine and recommend the third multimedia content to the user 114. In an embodiment, the third multimedia content, recommended by the processor 302, may be streamed to the first electronic device 102a associated with the user 114, via the multimedia distribution channel 112. In an embodiment, the third multimedia content may be streamed to the second electronic device 102b associated with the user 114, via the multimedia distribution channel 112.

In an embodiment, the processor 302 may be operable to recommend the third multimedia content to the user 114 associated with the first electronic device 102a, while the first electronic device 102a executes the first application and/or the second application. In an embodiment, the processor 302 may be operable to recommend the third multimedia content to the user 114 associated with the second electronic device 102b, while the second electronic device 102b executes another application.

In an embodiment, the processor 302 may be operable to receive another plurality of user preferences from another user associated with the first electronic device 102a or the second electronic device 102b. Based on a correlation of another plurality of user preferences, the processor 302 may be operable to determine and recommend another multimedia content to another user. The processor 302 may be further operable to stream another multimedia content to any electronic device associated with another user.

In an embodiment, the processor 302 may be operable to receive a plurality of the first plurality of user preferences from a group of the user 114 and the one or more other users, associated with the first electronic device 102a executing a multi-player gaming application. In such a case, processor 302 may be operable to determine a plurality of second multimedia content based on a correlation of the plurality of first plurality of user preferences received from the group. The processor 302 may be further operable to recommend the plurality of second multimedia content to respective users of the group. The processor 302 may be further operable to stream the plurality of second multimedia content to respective users associated with any electronic device.

In an embodiment, the processor 302 may be operable to recommend the first multimedia content, the second multimedia content and/or the third multimedia content to one or more other users suggested by the user 114. Such one or more other users may be socially connected with the user 114 via the social network, based on one or more similar parameters. Based on the recommendation, the first multimedia content, the second multimedia content and/or the third multimedia, may be streamed to one or more other electronic devices associated with the one or more other users, by the processor 302 via the transceiver 306. Such a first multimedia content, a second multimedia content and/or a third multimedia, may be streamed to the one or more other electronic devices through the multimedia distribution channel 112.

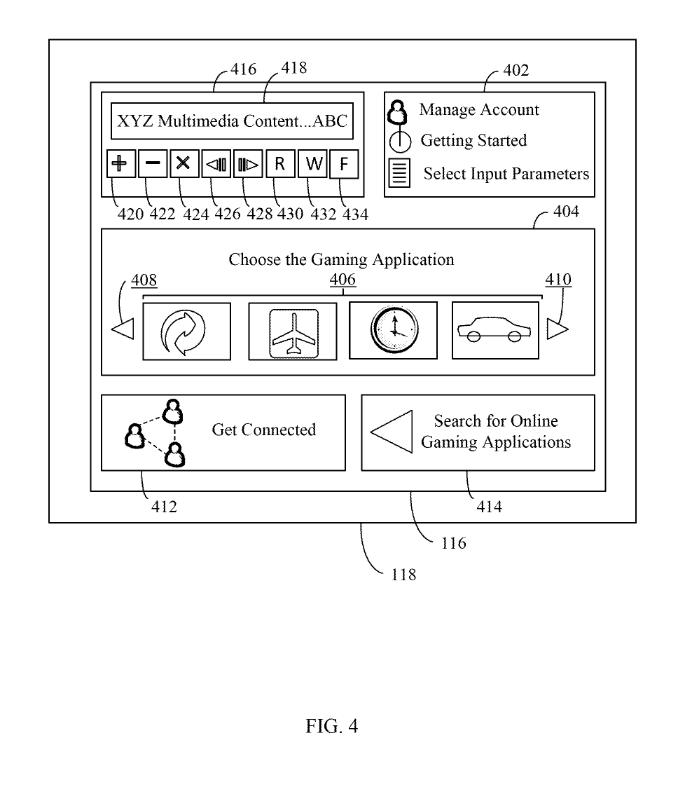

FIG. 4 illustrates an exemplary instance of an exemplary electronic device, in accordance with an embodiment of the disclosure. FIG. 4 is explained in conjunction with elements from FIG. 1, FIG. 2, and FIG. 3.

With reference to FIG. 4, there is shown the display screen 118 rendering the interface 116, which corresponds to the online gaming application executed at the first electronic device 102a. The interface 116 includes a first display segment 402, a second display segment 404, a plurality of selectable gaming applications 406, and two navigable icons 408 and 410 associated with the plurality of selectable gaming applications 406. The interface 116 further includes a first option, ‘Get Connected’ 412, and a second option ‘Search for Online Gaming Applications’ 414. The interface 116 further includes a multimedia interface 416 for rendering the multimedia content received from the multimedia server 106.

The first display segment 402 may illustrate a plurality of options selectable by the user 114 associated with the first electronic device 102a executing the online gaming application. A first option, ‘Manage Account’, when selected, may facilitate the user 114 to manually edit/update his account settings. Such account settings may include a first set of details about the user 114 that require manual input by the user 114. Examples of details of the user 114 may include an area of interest, an activity of interest, an educational background, a professional background, a relationship status, a favorite multimedia content, a social network connection or other demographic details of the user 114, associated with the first electronic device 102a executing the application.

Such account settings may also include a second set of details about the user 114 that are populated automatically in the ‘Manage Account’ option. Examples of second details may include preferences of the user 114 for a specific multimedia content based on a frequency of usage, multimedia content consumption behavior of the user 114, viewing/listening history of the user 114, past multimedia purchases, and/or the like.

A second option, ‘Get Started’, when selected, may perform a soft-booting of the online gaming application. The second option, ‘Get Started’, may be selected in a case when the online gaming application stops working due to internal software conflicts.

A third option, ‘Select Input Parameters’, when selected, may prompt the user 114 to provide a set of input parameters, for example, beats per minute (BPM) of the second multimedia content, mood of the user 114, a desired genre of the second multimedia content, a year range of the second multimedia content, a running time of the second multimedia content, one or more keywords related to the second multimedia content, or an identification of the second multimedia content. The sensing device 210 of the first electronic device 102a may be operable to receive biometric input, for example facial expressions or a speech input from the user 114. The processor 202 may receive such biometric input from the sensing device 210 and may populate the biometric input in one or more parameters in the ‘Select Input Parameters’ option.

The second display segment 404 may correspond to the online gaming application illustrating the plurality of selectable gaming applications 406 being scrolled, based on the two navigable icons 408 and 410. The two navigable icons 408 and 410 may be, for example, a left arrow and a right arrow, selectable to scroll the plurality of selectable gaming applications 406, towards a left horizontal direction and a right horizontal direction, respectively. Such a plurality of selectable gaming applications 406 may be pre-stored in the memory 204 of the first electronic device 102a, and thus may be referred to as offline gaming applications.

The first option, ‘Get Connected’ 412, when selected by the user 114, may enable the user 114 to socially connect to one or more other users in a social network. Such a social network may be provided by the social networking server 108. The social connection of the user 114 with the one or more other users in a social network, facilitates the user 114 to play multi-player online games with the one or more other users.

The second option ‘Search for Online Gaming Applications’ 414 when selected by the user 114 may enable the user 114 to search for online gaming applications hosted by the online application server 104. Such online gaming applications may be a single-player gaming application, for example, Penthouse Pool®, or a multi-player gaming application, for example, Big Farm®. For the multi-player gaming application, the user 114 may also have to select the option ‘Get Connected’ 412. Such online gaming applications hosted by the online application server 104 may be paid applications or free applications.

A multimedia interface 416 may be a display segment which corresponds to a multimedia content rendered on the display screen 118 of the first electronic device 102a. In an embodiment, the multimedia content may be a first multimedia content rendered during the execution of one of an offline gaming application or an online gaming application. In an embodiment, the multimedia content may be a recommended multimedia content rendered during the execution of one of an offline gaming application or an online gaming application based on the plurality of user preferences. In another embodiment, the multimedia content may be a second multimedia content rendered during the execution of one of an offline gaming application or an online gaming application based on the set of metadata determined from the first multimedia content.

The multimedia interface 416 may include a title 418 which corresponds to the multimedia content rendered on the display screen 118 of the first electronic device 102a. The title 418 may include initials of the rendered multimedia content as well as the initials of the artist of the rendered multimedia content.

The multimedia interface 416 may include a plurality of selectable options displayed which correspond to the multimedia content rendered on the display screen 118 of the first electronic device 102a. A first option 420 may be selectable by the user 114 to rate appreciation of the multimedia content rendered on the display screen 118. A second option 422 may be selectable by the user 114 to indicate dislike of the multimedia content rendered on the display screen 118. A third option 424 may be selectable by the user 114 to block the multimedia content rendered on the display screen 118. Such a blocking may prevent a future recommendation of multimedia content having the same or similar characteristics as that of the blocked multimedia content. A fourth option 426 may be selectable by the user 114 to skip backward through the multimedia content rendered on the display screen 118. A fifth option 428 may be selectable by the user 114 to skip forward through the multimedia content rendered on the display screen 118. A sixth option 430 may be selectable by the user 114 to provide an alpha-numeric rating for the multimedia content rendered on the display screen 118. A seventh option 432 may be selectable by the user 114 to provide a window for displaying an audio-visual multimedia content rendered on the display screen 118. An eighth option 434 may be selectable by the user 114 to add the recommended multimedia or the second multimedia in a ‘Favorite List’ of the user 114. In an embodiment, based on the multimedia content present in the ‘Favorite List’, the user 114 may be linked to one or more other multimedia servers, for example, iTunes®, for purchasing a digital download of the multimedia content present in the ‘Favorite List’. In another example, the user 114 may be linked to Amazon® to purchase a compact disc (CD) of the multimedia content present in the ‘Favorite List’.

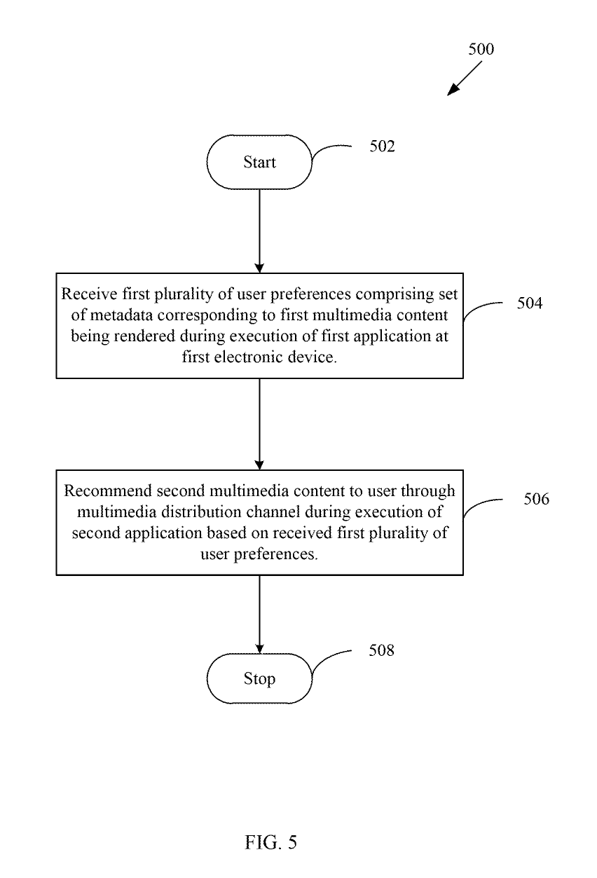

FIG. 5 is a flowchart illustrating a method for recommending multimedia content, in accordance with an embodiment of the disclosure. FIG. 5 is described in conjunction with elements of FIG. 1. The method 500 may be implemented in the multimedia server 106, communicatively coupled to the first electronic device 102a, the online application server 104, and the social networking server 108 via the communication network 110.

The method 500 begins at step 502 and proceeds to step 504. At step 504, the processor 302 in the online application server 104 may be operable to receive a first plurality of user preferences during an execution of a first application at the first electronic device 102a. The received first plurality of user preferences may comprise a set of metadata, which corresponds to a first multimedia content rendered during the execution of the first application.

At step 506, the processor 302 in the multimedia server 106 may be operable to recommend second multimedia content to the user 114 through the multimedia distribution channel 112 during execution of a second application based on the received first plurality of user preferences. The user 114 may be associated with the first electronic device 102a during the execution of the first application and the second application.

In an embodiment, the processor 302 in the multimedia server 106 may be operable to recommend the second multimedia content to the second application executed by the second electronic device 102b through the multimedia distribution channel 112. The user 114 may be associated with the second electronic device 102b during the execution of another application. Control then passes to end step 508.

In accordance with another embodiment of the disclosure, a system for recommending multimedia content is presented. Exemplary aspects of the disclosure may comprise one or more processors and/or circuits, such as the processor 302 (FIG. 3), in the multimedia server 106 (FIG. 1). The processor 302 may be operable to receive a first plurality of user preferences. The received first plurality of user preferences may include a set of metadata, which corresponds to a first multimedia content rendered during execution of the first application at the first electronic device. The processor 302 may be operable to recommend second multimedia content to the user 114 (FIG. 1) through a multimedia distribution channel 112 (FIG. 1) during execution of the second application based on the received first plurality of user preferences.

In an embodiment, the processor 302 may be operable to recommend the second multimedia content with one or more other users connected to the user 114 in a social network. In an embodiment, the processor 302 may be operable to recommend the second multimedia content to the second electronic device 102b (FIG. 1) through the multimedia distribution channel 112. The user 114 may be associated with the first electronic device 102a during execution of the second application.

In an embodiment, the processor 302 may be operable to recommend the second multimedia content to another application executed by the second electronic device 102b through the multimedia distribution channel 112. The second electronic device 102b may be communicably coupled to the multimedia server 106. The user 114 may be associated with the second electronic device 102b during execution of another application. In an embodiment, the second multimedia content may be a promotional multimedia content.

In an embodiment, the user may be associated with the first electronic device 102a (FIG. 1) during execution of the first application and the second application.

Other embodiments of the disclosure may provide a non-transitory computer readable medium and/or storage medium, and/or a non-transitory machine readable medium and/or storage medium. Having applicable mediums stored thereon, a machine code and/or a computer program having at least one code section executable by a machine and/or a computer for recommending multimedia content, may thereby cause the machine and/or computer to perform the steps comprising in a multimedia server communicatively coupled to a first electronic device and a second electronic device. The first electronic device associated with a user may be operable to execute a first application and a second application. The second electronic device associated with the user may be operable to execute the second application. The machine and/or computer performs the steps comprising receiving a first plurality of user preferences. The received first plurality of user preferences may include a set of metadata, which correspond to a first multimedia content rendered during the execution of the first application at the first electronic device. The machine and/or computer further performs the steps comprising recommending second multimedia content to the user through a multimedia distribution channel during execution of the second application based on the received first plurality of user preferences.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for recommending multimedia content, said method comprising:
in a server communicatively coupled to a first electronic device, said first electronic device operable to execute a first application and a second application:
receiving a first plurality of user preferences, wherein said received first plurality of user preferences comprises a set of metadata corresponding to a first multimedia content rendered during execution of said first application at said first electronic device; and
recommending second multimedia content to a user through a multimedia distribution channel during execution of said second application based on said received first plurality of user preferences.

2. The method of claim 1, wherein said first application and said second application are one of: an online game, a console based game, a browser based game, a cloud based game, a mobile based game, or a tablet based game.

3. The method of claim 1, wherein said second application is a multimedia application or a web application.

4. The method of claim 1, wherein said set of metadata comprises one or more of: a title captured from said first multimedia content, an artist captured from said first multimedia content, an album captured from said first multimedia content, a year of release of multimedia content captured from said first multimedia content, and/or a user rating corresponding to said first multimedia content.

5. The method of claim 1, wherein said received first plurality of user preferences comprises a set of input parameters provided by said user and/or a user profile of said user.

6. The method of claim 5, wherein said set of input parameters comprises one or more of: beats per minute (BPM) of said second multimedia content, mood of said user, a desired genre of said second multimedia content, a year range of said second multimedia content, a running time of said second multimedia content, one or more keywords related to said second multimedia content, a biometric input, and/or an identification of said second multimedia content.

7. The method of claim 5, wherein said user profile of said user comprises one or more of: preferences of a specific multimedia content based on a numerical value or a graphical indication, multimedia content consumption behavior of said user, viewing or listening history of said user, subscription details of said user, multimedia purchases, favorite multimedia content, or demographic details of said user.

8. The method of claim 1, comprising correlating said set of metadata, a set of input parameters, and/or a user profile of said user associated with said first electronic device during execution of said first application.

9. The method of claim 8, comprising determining said second multimedia content based on said correlating.

10. The method of claim 1, wherein said recommended second multimedia content is a promotional multimedia content.

11. The method of claim 1, comprising recommending said second multimedia content to said second application through said multimedia distribution channel, wherein said user is associated with said first electronic device during execution of said second application.

12. The method of claim 1 comprising recommending said second multimedia content to another application executed by a second electronic device through said multimedia distribution channel, wherein said second electronic device is communicably coupled to said server.

13. The method of claim 1, comprising receiving a second plurality of user preferences based on said recommended second multimedia content.

14. The method of claim 13, comprising determining third multimedia content based on said first plurality of user preferences and said second plurality of user preferences.

15. The method of claim 1, wherein said user is associated with said first electronic device during execution of said first application and said second application.

16. A system for recommending multimedia content, said system comprising:
in a server comprising one or more processors, said server communicatively coupled to a first and a second electronic device, said first electronic device operable to execute a first application and a second application, said one or more processors being operable to:
receive a first plurality of user preferences, wherein said received first plurality of user preferences comprises a set of metadata corresponding to a first multimedia content rendered during execution of said first application at said first electronic device; and
recommend second multimedia content to a user through a multimedia distribution channel during execution of said second application based on said received first plurality of user preferences.

17. The system of claim 16, wherein said one or more processors are operable to recommend said second multimedia content to one or more other users connected to said user in a social network.

18. The system of claim 16, wherein said one or more processors are operable to recommend said second multimedia content to said second application through said multimedia distribution channel, wherein said user is associated with said first electronic device during execution of said second application.

19. The system of claim 16, wherein said one or more processors are operable to recommend said second multimedia content to said another application executed by said second electronic device through said multimedia distribution channel, wherein said second electronic device is communicably coupled to said server.

20. The system of claim 16, wherein said recommended second multimedia content is a promotional multimedia content.

21. The system of claim 16, wherein said user is associated with said first electronic device during execution of said first application and said second application.

22. A non-transitory computer-readable storage medium having stored thereon, a computer program having at least one code section for recommending multimedia content, the at least one code section being executable by a computer for causing the computer to perform steps comprising:
in a server communicatively coupled to a first and a second electronic device, said first electronic device operable to execute a first application and a second application, said second electronic device operable to execute said second application:
receiving a first plurality of user preferences, wherein said received first plurality of user preferences comprises a set of metadata corresponding to a first multimedia content rendered during execution of said first application at said first electronic device; and
recommending second multimedia content to a user through a multimedia distribution channel during execution of said second application based on said received first plurality of user preferences.
